(19) United States
(12) Patent Application Publication
(10) Pub. No.: US 2026/0320588 A1
(43) Pub. Date: Oct. 15, 2026

(54) INTEGRATED VEHICLE ACCESS AND USAGE TRACKING SYSTEM

(71) Applicant: Standard Fleet, Inc., Covina, CA (US)

(72) Inventors: Thomas Athan, Covina, CA (US); Michelle Cunningham, Covina, CA (US); Steffen Hanikel, Covina, CA (US); David Hodge, Covina, CA (US); Ian Leighton, Covina, CA (US); Christopher Moore, Covina, CA (US); Taylor Malloy, Covina, CA (US); Lex-Daniel Nastin, Covina, CA (US); Andrew Robinson, Covina, CA (US)

(21) Appl. No.: 19/720,469

(22) Filed: Jun. 25, 2026

Related U.S. Application Data
(62) Division of application No. 19/182,262, filed on Apr. 17, 2025.
(60) Provisional application No. 63/635,081, filed on Apr. 17, 2024.

(51) Int. Cl. G06Q 20/36; G06Q 20/12; G06Q 20/40

(52) U.S. Cl. CPC G06Q 20/3674; G06Q 20/127; G06Q 20/401

(57) ABSTRACT

Methods are described to provide a digital vehicle key with integrated support for tracking charging. A method comprises causing storage of a digital vehicle key comprising a vehicle identifier and a user identifier, wherein the digital vehicle key enables access and operation of a vehicle associated with the vehicle identifier. The method further comprises providing the digital vehicle key to a mobile device associated with the user identifier. The method further comprises retrieving vehicle usage data associated with the vehicle identifier. The method further comprises adding a transaction into a queue for a digital account associated with the user identifier, wherein the transaction includes a value based on the vehicle usage data. Other methods are also provided for home charging tracking and for disabling operation of a vehicle via a digital vehicle key when detecting unsafe conditions or a past due account.

### CROSS-REFERENCE TO RELATED APPLICATIONS

This application claims the benefit as a divisional of Application Serial No. 19/182,262, filed Apr. 17, 2025, the entire contents of which is hereby incorporated by reference, which claims the benefit under 35 U.S.C. §119(e) of provisional application 63/635,081, filed Apr. 17, 2024, by Athan et al., the entire contents of which is hereby incorporated by reference.

### TECHNICAL FIELD

The present disclosure relates to digital access control systems for connected vehicles. In particular, a digital vehicle key with integrated support for charge tracking is provided.

### BACKGROUND

With the continued transition to vehicles using electrical charging and other renewable energy sources, there is a growing need to track charging history from the usage of such vehicles. In the case of leasing, rentals, employee vehicles, and other temporary ownership arrangements, vehicle usage history (e.g., electrical charging, mileage, maintenance, tolls, and other incidentals) are often accounted for directly to the original owner of the vehicle. Thus, it becomes difficult and time consuming to manually track and reconcile vehicle usage by a renter, employee, or other non-owner of the vehicle.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system in which a digital vehicle key with integrated support for charging reimbursement may be supported.

FIG. 2A is a flow diagram that depicts an example process that a server may perform to provide a digital vehicle key to a mobile device and reimburse for expenses incurred from usage of the digital vehicle key.

FIG. 2B is a flow diagram that depicts an example process that a server may perform to generate, store, and provide a digital vehicle key to the mobile device.

FIG. 2C is a flow diagram that depicts an example process that a server may perform to track and reimburse for expenses incurred from usage of a digital vehicle key.

FIG. 2D is a flow diagram that depicts an example process that a server may perform to reimburse for expenses incurred after expiration or return of a digital vehicle key.

FIG. 2E is a flow diagram that depicts an example process that a server may perform to provide a digital vehicle key to a mobile device and reimburse for a charging session.

FIG. 2F is a flow diagram that depicts an example process that a server may perform to determine valid charging sessions and provide periodic reimbursement.

FIG. 2G is a flow diagram that depicts an example process that a mobile device may perform to disable vehicle operation via a digital vehicle key when an associated account is past due.

FIG. 3A is a sequence diagram that depicts an example process to generate a digital vehicle key.

FIG. 3B is an example user interface on a mobile device for associating a digital account with a digital vehicle key.

FIG. 4A is a sequence diagram that depicts an example process to obtain a digital vehicle key and a vehicle state using a secure lookup token.

FIG. 4B is an example user interface on a mobile device for operation of a vehicle using a digital vehicle key.

FIG. 5A is a sequence diagram that depicts an example process to send commands to operate a vehicle using various protocols.

FIG. 5B is an example user interface on a mobile device showing disabled operation of a vehicle via a digital vehicle key when an associated account is past due.

FIG. 5C is an example user interface on a mobile device showing disabled operation of a vehicle via a digital vehicle key when an unsafe condition is detected.

FIG. 6A is a sequence diagram that depicts an example process to gather charge events for periodic reimbursement.

FIG. 6B is an example user interface for an employer to provide a digital vehicle key with charge reimbursement to an employee.

FIG. 7 illustrates a block diagram of a computing device in which the example embodiment(s) of the present invention may be embodiment.

FIG. 8 illustrates a block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

A digital vehicle key with integrated support for tracking charging and other vehicle usage events is provided. As electric and other renewable energy vehicles increasingly support unlocking and operations via digital vehicle keys, embodiments described herein provide improvements to such keys by integrating automatic tracking features. In this manner, rentals, leases, and other temporary ownership arrangements can be seamlessly supported to compensate companies or original owners for charging costs and other incidentals automatically, thereby advantageously avoiding manual account reconciliation. Keys may also be disabled when outstanding balances exceed a threshold, thereby assisting with loss prevention efforts. Home charging sessions can also be compensated to users according to estimated electricity rates, thereby facilitating employer sponsored vehicle arrangements.

### EXAMPLE SYSTEM FOR DIGITAL VEHICLE KEY WITH REIMBURSEMENT

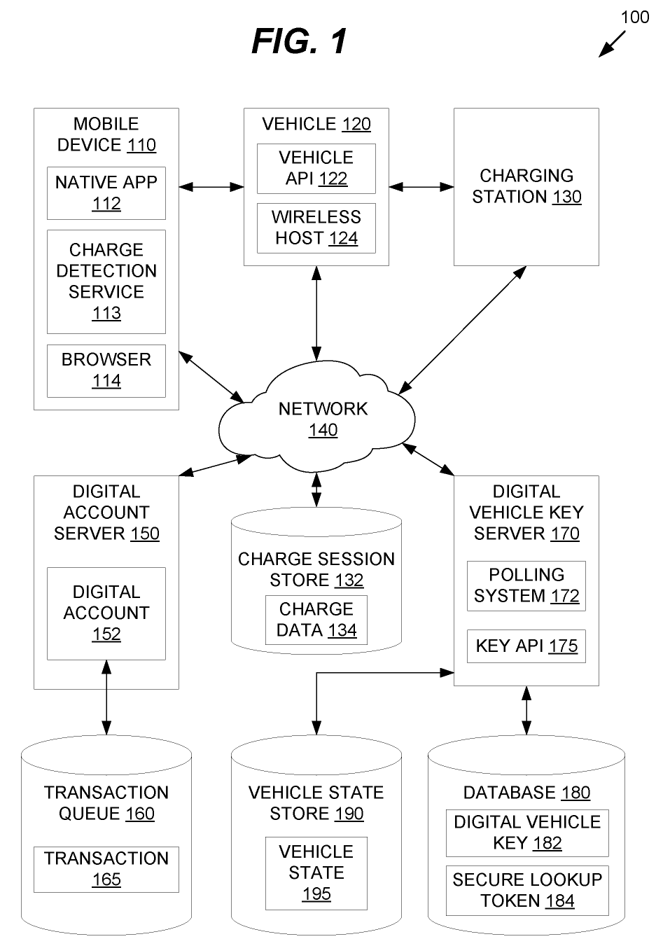

FIG. 1 is a block diagram that depicts an example system 100 in which a digital vehicle key 182 with integrated support for charge tracking may be supported. System 100 includes mobile device 110, vehicle 120, charging station 130, charge session store 132, network 140, digital account server 150, transaction queue 160, digital vehicle key server 170, database 180, and vehicle state store 190. Mobile device 110 includes native app 112, charge detection service 113, and browser 114. Vehicle 120 includes vehicle application programming interface (API) 122 and wireless host 124. Charge session store 132 includes charge data 134. Digital account server 150 includes digital account 152. Transaction queue 160 includes transaction 165. Digital vehicle key server 170 includes polling system 172 and key API 175. Database 180 includes digital vehicle key 182 and secure lookup token 184.

Mobile device 110 may comprise a smartphone, a wearable device such as a watch or augmented reality (AR) glasses, a key fob, or another portable device that is carried or worn by a user. Mobile device 110 may include one or more wireless radios to communicate with network 140, e.g. the Internet, and wireless host 124, which may support one or more wireless radio protocols such as Bluetooth (BT) / Bluetooth Low Energy (BLE), near-field communication (NFC), ultra-wideband (UWB), and others.

Vehicle 120 may correspond to an electric vehicle (EV), a vehicle using renewable fuel sources, or any connected vehicle regardless of fuel source. Mobile device 110 may utilize native app 112, corresponding to a native binary application, or browser 114, which may access a web-based application, to send commands to vehicle 120 for unlocking and vehicle operation. For example, mobile device 110 may send commands directly to vehicle 120 via wireless host 124, or indirectly via network 140 using vehicle API 122.

Multiple protocols may be attempted in a preferred hierarchy to communicate with vehicle 120, for example by prioritizing protocols with the lowest latency with higher latency methods as fail-safe methods. In this manner, reliable access to vehicle 120 is thereby provided. The availability of specific protocols may depend on whether a pairing or authentication process was previously completed between mobile device 110 and vehicle 120, and whether native app 112 or browser 114 is being utilized. For example, browser 114 may have limited or restricted access to certain wireless radios of mobile device 110 in comparison to native app 112. In some implementations, mobile device 110 may automatically unlock vehicle 120 when in proximity to vehicle 120, e.g. when native app 112 establishes communication with wireless host 124.

Charging station 130 may correspond to a public charging station or a charger installed at a home location. When vehicle 120 initiates a charging session with charging station 130, it is desirable to record details of the charging event so that an associated reimbursement can be provided to the correct party, such as a rental / leasing company or the original vehicle owner. In some cases, the reimbursement is provided to the user who is currently in possession of vehicle 120, such as when a company provides a company sponsored vehicle and wishes to reimburse the user for vehicle charging electricity costs. The charging event can be stored as charge data 134 within charge session store 132. When charging station 130 is a home charger, charge detection service 113 may detect the charging session and store charge data 134. When charging station 130 is within a public charging network, charging station 130 may store charge data 134.

Digital account server 150 may provide payment processing and transfer services. A user who owns digital account 152 can send a request to add transaction 165 to transaction queue 160, for example to transfer currency to another digital account. Prior to obtaining digital vehicle key 182, mobile device 110 may be required to perform an onboarding process to register digital account 152 with digital vehicle key 182. Native app 112, browser 114, or digital vehicle key server 170 can automatically send transaction requests to digital account server 150 in connection with usage of digital vehicle key 182 to provide automatic charging reimbursement.

Digital vehicle key server 170 may handle the creation, storage, and provisioning of digital vehicle keys via key API 175. Secure lookup token 184 may be used to identify and lookup digital vehicle key 182 in database 180. Digital vehicle key 182 may utilize a digital key standard such as a Car Connectivity Consortium Digital Key (CCC Digital Key). Polling system 172 may periodically poll vehicle 120 using vehicle API 122 to update vehicle state 194 in vehicle state store 190. For example, vehicle state 195 may include details such as whether doors and hoods are locked or unlocked, whether windows are open or closed, whether the engine is running, climate control state, and so forth. When supported by vehicle API 122, polling system 172 may instead receive push notifications or issue pull requests to retrieve state updates.

### PROVIDING A DIGITAL VEHICLE KEY

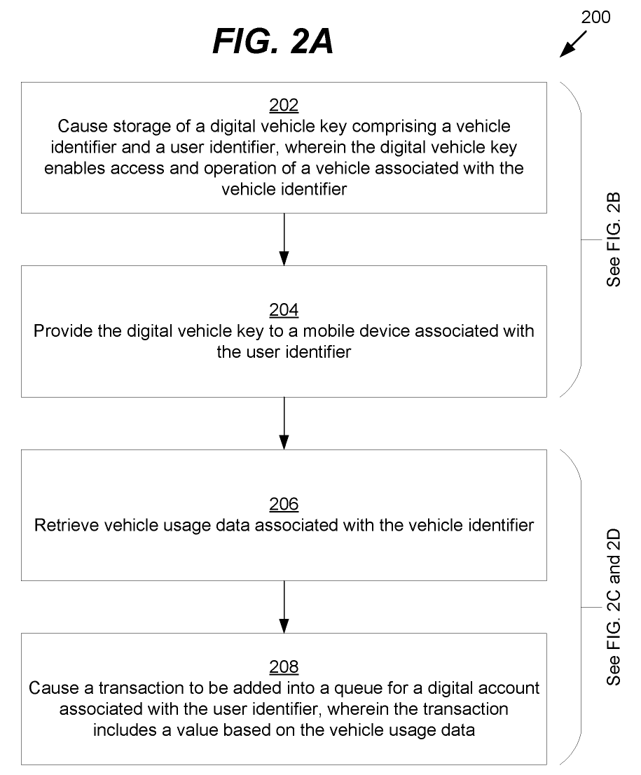

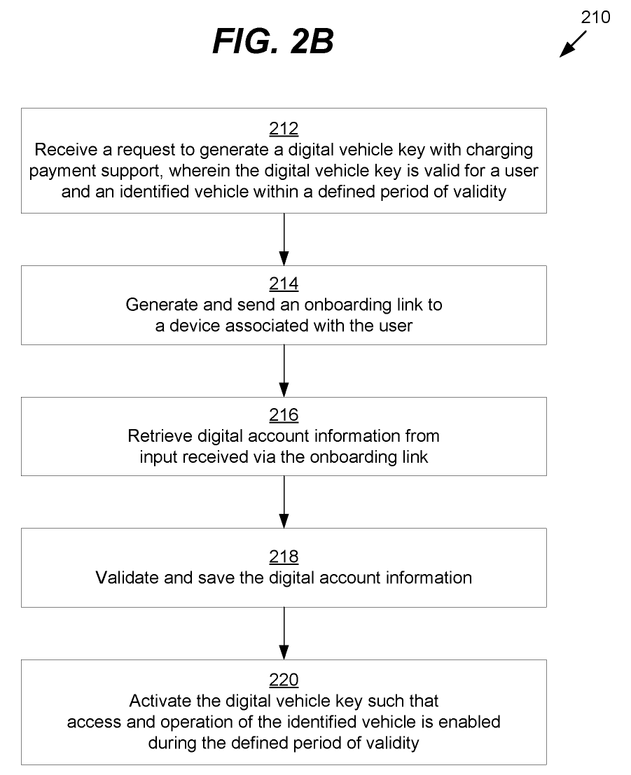

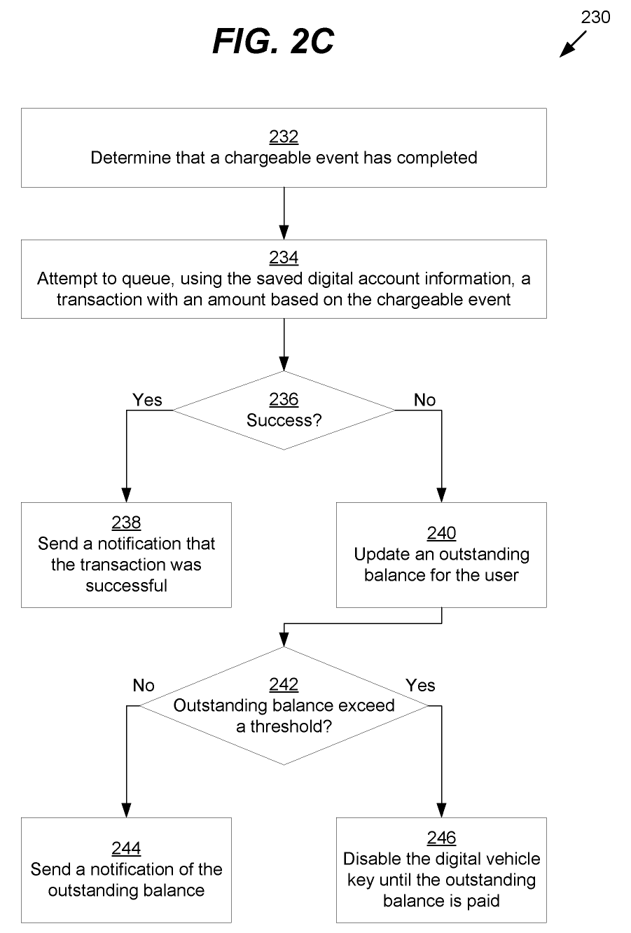

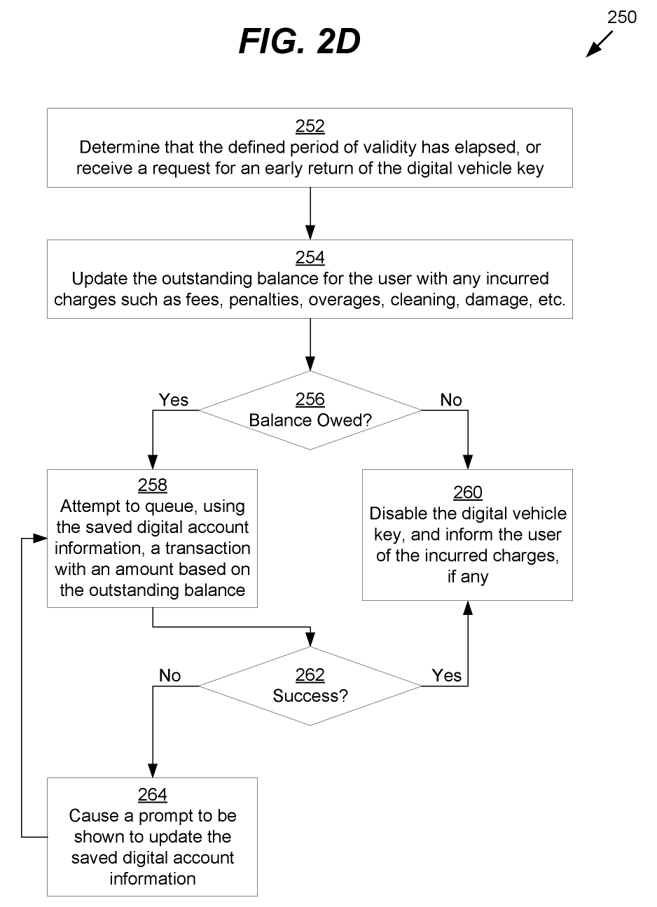

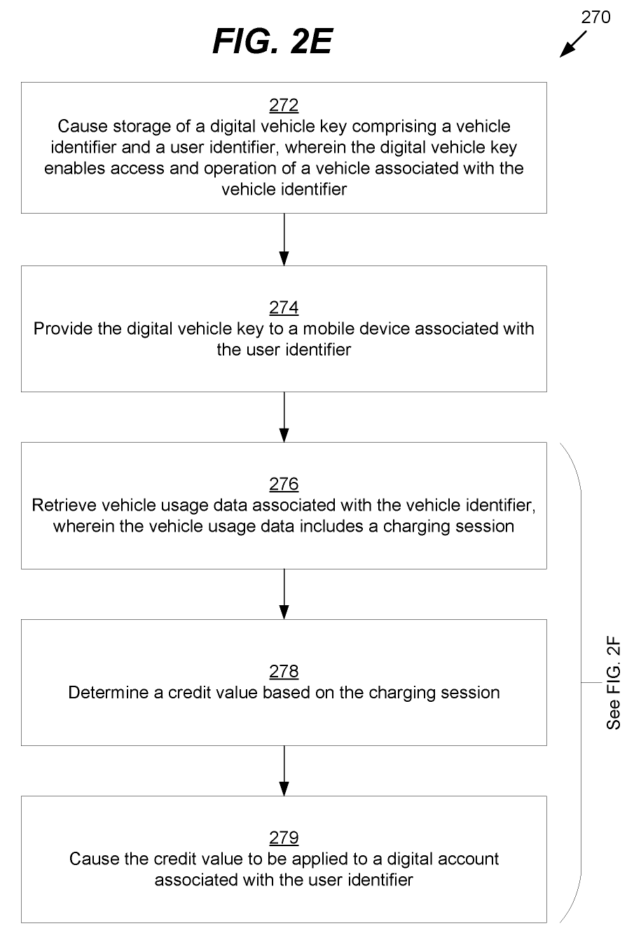

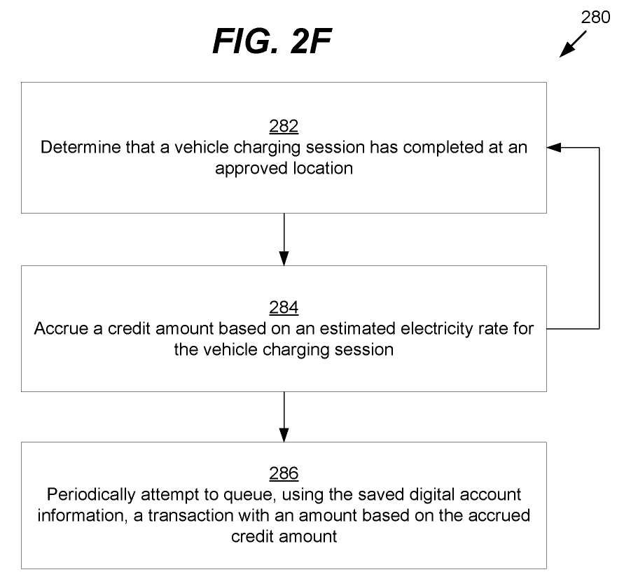

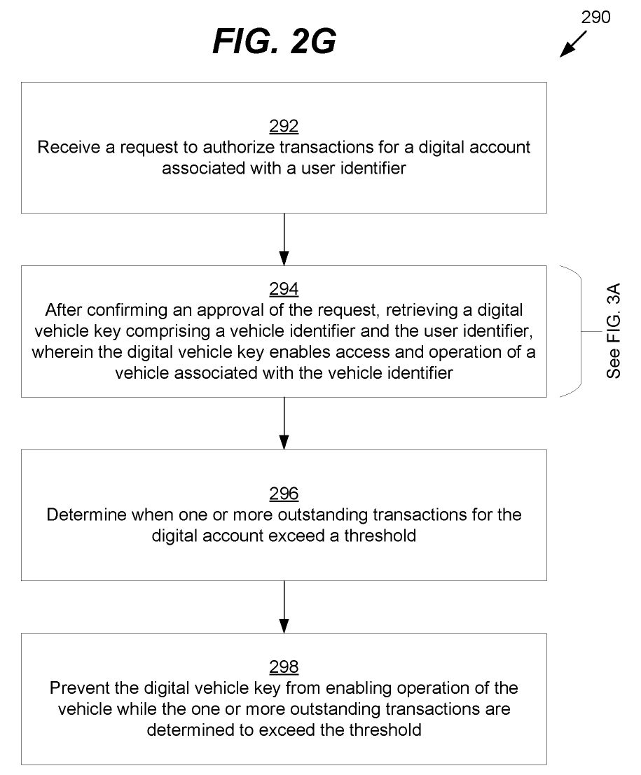

FIG. 2A is a flow diagram that depicts an example process 200 that digital vehicle key server 170 may perform to provide digital vehicle key 182 to mobile device 110 and reimburse for expenses incurred from usage of digital vehicle key 182. As shown in FIG. 2A, an example implementation of block 202 and block 204 is further detailed in FIG. 2B, and an example implementation of block 206 and block 208 is further detailed in FIG. 2C and FIG. 2D.

Referring to FIG. 1, in block 202, digital vehicle key server 170 causes storage of digital vehicle key 182 comprising a vehicle identifier and a user identifier, wherein digital vehicle key 182 enables access and operation of vehicle 120 associated with the vehicle identifier. For example, digital vehicle key server 170 may issue a structured query language (SQL) INSERT command to store digital vehicle key 182 in database 180. An associated secure lookup token 184 may also be stored, which allows identification and retrieval of digital vehicle key 182 from database 180.

In block 204, digital vehicle key server 170 provides digital vehicle key 182 to mobile device 110 associated with the user identifier. For example, after an onboarding link is sent to mobile device 110 and digital account 152 is linked to the user identifier, digital vehicle key 182 can be provided to mobile device 110 via network 140.

In block 206, digital vehicle key server 170 retrieves vehicle usage data, such as charge data 134, associated with the vehicle identifier. For example, charge data 134 may be requested from charge session store 132 and transferred via network 140. Vehicle usage data may include other chargeable event data besides vehicle charging events and may generally include any telematics generated and recorded by vehicle 120.

In block 208, digital vehicle key server 170 causes transaction 165 to be added into transaction queue 160 for digital account 152 associated with the user identifier, wherein the transaction includes a value based on charge data 134. Transaction 165 may correspond to a transfer from digital account 152 to a beneficiary digital account that is separate from digital account 152, e.g. an account owned by a vehicle leasing / rental company or the original owner of vehicle 120. Note that for clarity and brevity purposes, different transactions herein may be generically referred to as “transaction 165,” and thus it should be understood that references to “transaction 165” may not necessarily refer to the same transaction.

### GENERATING, STORING, AND SENDING A DIGITAL VEHICLE KEY

FIG. 2B is a flow diagram that depicts an example process 210 that digital vehicle key server 170 may perform to generate, store, and provide digital vehicle key 182 to mobile device 110.

Referring to FIG. 1, in block 212, digital vehicle key server 170 receives a request to generate digital vehicle key 182 with charging payment support, wherein digital vehicle key 182 is valid for a user and vehicle 120 within a defined period of validity. For example, the user may visit a vehicle rental website or in-person office to request a rental of vehicle 120 for a rental period between Jan. 31 and Feb. 5.

In block 214, digital vehicle key server 170 generates and sends an onboarding link to mobile device 110, which is associated with the user. For example, as part of the request in block 212, the user may provide a phone number, e-mail address, or other identifier that is linked to mobile device 110. This identifier can then be utilized to generate and send an onboarding link, e.g. by sending a short message service (SMS) message, iMessage, e-mail, push notification, webhook, or any other type of message. Additionally, or alternatively, the link may be provided on paper or shown on a display, such as via a quick response code (QR code) or a Uniform Resource Locator (URL).

In block 216, digital vehicle key server 170 retrieves information for digital account 152 from input received via the onboarding link of block 214. For example, the onboarding link may trigger native app 112 or browser 114 to prompt the user to enter payment details, such as credit or debit card details, bank account details, or other payment account details linked to digital account 152. This information may then be retrieved via a secure channel, such as Hypertext Transfer Protocol Secure (HTTPS), over network 140. Alternatively, the payment details may be provided in advance with the initial request at block 212.

In block 218, digital vehicle key server 170 validates and saves the digital account information from block 216. For example, digital account server 150 may be contacted over network 140 to inquire whether digital account 152 is valid, or a low value test transaction may be attempted to determine whether digital account 152 is valid. If it is not valid, process 210 may return to block 214 to prompt the user to enter an alternative digital account. Otherwise, digital account 152 is validated and the information may be saved in a secure location, such as database 180 or another secure store.

In block 220, digital vehicle key server 170 activates digital vehicle key 182 such that access and operation of vehicle 120 is enabled during the defined period of validity. For example, digital vehicle key server 170 may instruct native app 112 and/or a web application accessed via browser 114 that digital vehicle key 182 is valid for the rental period of Jan. 31 to Feb. 5. Accordingly, native app 112 and/or browser 114 is enabled to utilize digital vehicle key 182 to unlock and operate vehicle 120 during the period of validity.

### REIMBURSING INCURRED EXPENSES AND RESTRICTING KEY USAGE

FIG. 2C is a flow diagram that depicts an example process 230 that digital vehicle key server 170 may perform to track and reimburse for expenses incurred from usage of digital vehicle key 182.

Referring to FIG. 1, in block 232, digital vehicle key server 170 determines that a chargeable event has completed. For example, polling system 172 may be used to determine if any new charging sessions are recorded in charge session store 132, and if so, charge data 134 may be retrieved. In another example, charging detection service 113 may determine that a new charging event has completed, and the charge event may be provided to digital vehicle key server 170. Besides charging sessions, chargeable events may also include other types of events that can be automatically detected or manually created. Examples of chargeable events may include an extension of validity for digital vehicle key 182, mileage overages, toll road usage, traffic tickets, and other events.

In block 234, digital vehicle key server 170 attempts to queue, using digital account 152, transaction 165 with an amount based on charge data 134. For example, charge data 134 may reflect the amount of energy transferred to vehicle 120 and based on estimated electricity rates for home charging or published rates for public charging, a monetary value can be determined for transaction 165. Digital vehicle key server 170 may then contact digital account server 150 to request transaction 165 to be queued in transaction queue 160.

In block 236, digital vehicle key server 170 determines whether block 234 was successful or not. If transaction 165 is determined to have successfully processed through transaction queue 160, then process 230 proceeds to block 238, wherein a notification is sent to mobile device 110 that transaction 165 was successful, e.g. by text message, push notification, webhooks, or other methods. If transaction 165 is determined to have failed to be processed through transaction queue 160, then process 230 proceeds to block 240, wherein an outstanding balance is updated for the user, and process 230 further proceeds to block 242.

In block 242, digital vehicle key server 170 determines whether the outstanding balance exceeds a threshold. For example, the threshold may be based on a maximum number of failed transaction attempts on digital account 152, and/or a threshold total amount owed. If the threshold is not exceeded, then process 230 proceeds to block 244, wherein a notification is sent to mobile device 110 that an outstanding balance exists, and invites the user to settle the balance. Otherwise, the threshold is exceeded, and process 230 proceeds to block 246, wherein digital vehicle key 182 is disabled for operating vehicle 120 until the outstanding balance is paid. For example, a message may be sent to mobile device 110 that causes native app 112 and/or browser 114 to restrict operation of vehicle 120 using digital vehicle key 182 until the outstanding balance is paid.

### REIMBURSING INCURRED EXPENSES AFTER DIGITAL VEHICLE KEY EXPIRATION

FIG. 2D is a flow diagram that depicts an example process 250 that digital vehicle key server 170 may perform to reimburse for expenses incurred after expiration or return of a digital vehicle key 182.

Referring to FIG. 1, in block 252, digital vehicle key server 170 determines that the defined period of validity has elapsed, or digital vehicle key server 170 receives a request for an early return of digital vehicle key 182. For example, based on the example period of validity from Jan. 31 to Feb. 5, digital vehicle key server 170 may determine that it is currently past Feb. 5, and digital vehicle key 182 is therefore invalid. In another example, the user may bring vehicle 120 to a drop-off location prior to the expiration of Feb. 5, and thus the user requests an early return of digital vehicle key 182. Optionally, the user may be given an opportunity to extend the period of validity, and a new or updated digital vehicle key 182 with an updated period of validity may be generated and issued to mobile device 110.

In block 254, digital vehicle key server 170 updates the outstanding balance for the user with any incurred charges due at the point of return such as late fees, penalties, mileage overages, cleaning fees, damages, premium option usage (e.g. vehicle connectivity packages), low battery charge level, etc. Many of these charges cannot be assessed until vehicle 120 is returned and able to be inspected. However, some charges can still be applied during the rental or validity period, such as the chargeable events described above in conjunction with FIG. 2C. In another example, usage data recorded by mobile device 110 and/or vehicle 120 may be utilized to assess fees, such as mileage overages, toll road usage, traffic tickets, and so forth.

In block 256, digital vehicle key server 170 determines whether a balance is owed after applying any available deposit to the outstanding balance. If no balance is owed, the rental is complete and process 250 proceeds to block 260, wherein digital vehicle key 182 is disabled and the user is informed of the incurred charges from block 254, if any. Otherwise, a balance is owed and process 250 proceeds to block 258, wherein a transaction 165 is attempted to be queued into transaction queue 160 for digital account 152 with an amount based on the balance owed determined in block 256. If the attempt is successful, then the rental is complete and process 250 proceeds to block 260. Otherwise, the attempt failed and process 250 proceeds to block 264.

In block 264, digital vehicle key server 170 causes a prompt to be shown on mobile device 110 to update the saved digital account information. Once updated digital account information is received, process 250 returns to block 258 to retry payment with the updated digital account.

### REIMBURSING A PUBLIC CHARGING SESSION

FIG. 2E is a flow diagram that depicts an example process 270 that digital vehicle key server 170 may perform to provide digital vehicle key 182 to mobile device 110 and reimburse for a charging session. As shown in FIG. 2E, an example implementation of block 276, block 278, and block 279 is further detailed in FIG. 2F.

Referring to FIG. 1, in block 272, digital vehicle key server 170 causes storage of digital vehicle key 182 comprising a vehicle identifier and a user identifier, wherein the digital vehicle key enables access and operation of vehicle 120 associated with the vehicle identifier. For example, digital vehicle key 182 may be generated as a CCC Digital Key that includes a vehicle identifier that uniquely identifies vehicle 120 and a user identifier that uniquely identifies the user of mobile device 110. Digital vehicle key 182 may also be generated as a proprietary format key that uses one or more protocols such as Bluetooth (BT) / Bluetooth Low Energy (BLE), near-field communication (NFC), ultra-wideband (UWB), and other protocols. Digital vehicle key 182 may also include additional data fields such as: a pickup location and one or more return drop-off locations for vehicle 120, a mileage allowance, user contact information such as e-mail and phone, vehicle identifiers, deposit information, and other data. Digital vehicle key 182 and the associated secure lookup token 184 may then be stored in database 180.

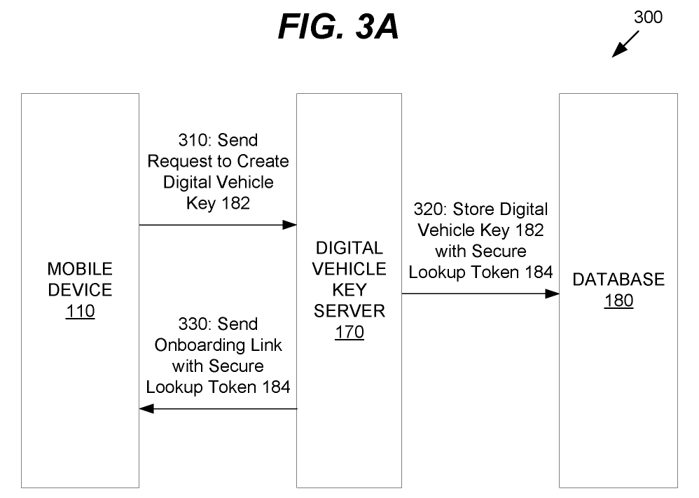

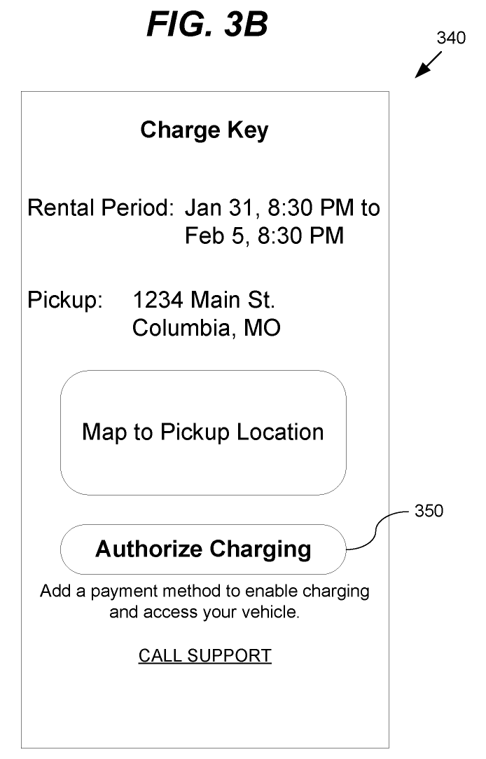

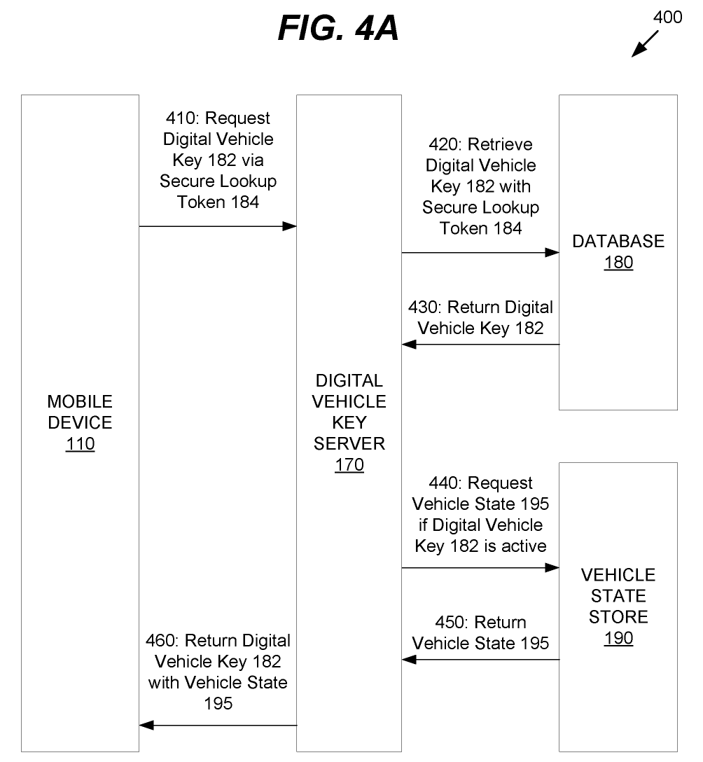

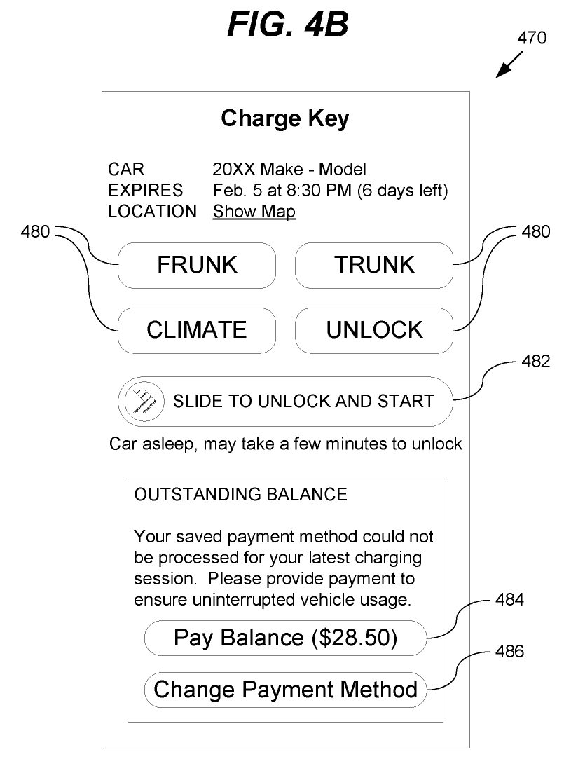

In block 274, digital vehicle key server 170 provides digital vehicle key 182 to mobile device 110 associated with the user identifier. For example, as discussed above in block 214 of FIG. 2B, an onboarding link may be sent to mobile device 110. The onboarding link may include secure lookup token 184, as described in further detail in conjunction with FIG. 3A below. When the onboarding process is successfully completed, mobile device 110 may request digital vehicle key 182 using secure lookup token 184, as described in further detail in conjunction with FIG. 4A below. Database 180 is then queried using secure lookup token 184, and the retrieved digital vehicle key 182 is returned to mobile device 110.

In block 276, digital vehicle key server 170 retrieves vehicle usage data associated with the vehicle identifier, wherein the vehicle usage data includes a charging session. For example, the vehicle usage data may include charge data 134 and may also include other usage data such as a mileage / odometer record, a toll usage record, and a traffic ticket record. The vehicle usage data may be retrieved via vehicle API 122, via charge detection service 113, via a charging network API provided by the owner of charging station 130, e.g. to access charge session store 132, or via data stored on mobile device 110.

In cases where the charging network associated with charging station 130 does not automatically associate charge data 134 with the user of vehicle 120, manual data entry may be used, e.g. by entering a location and stall number for charging station 130 when performing a charging session. This can then be used to lookup and retrieve charge data 134 from the charging network.

In some implementations, the vehicle usage data may be further used to generate and store a driver score that is associated with the user. The driver score can be used in future rentals to e.g. provide good driver discounts or impose penalties for higher risk drivers.

In block 278, digital vehicle key server 170 determines a credit value based on charge data 134. For example, when charge data 134 defines the total monetary amount, the credit value can be set directly accordingly. However, if charge data 134 only defines the amount of charge transferred to vehicle 120, then the credit value may be estimated, e.g. by using estimated electricity rates, as described further in conjunction with FIG. 2F below.

In block 279, digital vehicle key server 170 causes the credit value to be applied to digital account 152 associated with the user identifier. As discussed above, digital account server 150 may be contacted to request transaction 165 to be added to transaction queue 160, wherein the credit value is transferred to digital account 152, e.g. from an employer account. In some implementations, the credit value may be accrued and paid on a periodic basis, as described further in conjunction with FIG. 2F below.

### PERIODIC REIMBURSEMENT FOR HOME CHARGING SESSIONS

FIG. 2F is a flow diagram that depicts an example process 280 that digital vehicle key server 170 may perform to determine valid charging sessions and provide periodic reimbursement.

Referring to FIG. 1, in block 282, digital vehicle key server 170 determines that a vehicle charging session has completed at an approved location. For example, for employee sponsored vehicles, the employer may desire to restrict reimbursement to home charging only. In this case, the approved location includes the home address of the user. With regard to detecting the completed charging session, the process may proceed similar to block 232 in FIG. 2C as described above. With regard to the approved location, digital vehicle key server 170 may instruct mobile device 110 to use global positioning system (GPS), geolocation, and/or geofencing techniques to verify whether vehicle 120 is charging at an approved location.

In block 284, digital vehicle key server 170 accrues a credit amount based on an estimated electricity rate for the vehicle charging session. For example, the estimated electricity rate may be set according to a flat rate, a custom rate, or a utility rate, which may be location-based and include a time-of-use (TOU) rate that varies according to time of day and season. The estimated electricity rate may be further adjusted according to an estimated energy transfer efficiency loss. Blocks 282 and 284 may be repeated for each charging session that occurs between the periodic payouts of block 286.

In block 286, digital vehicle key server 170 periodically attempts to queue, using digital account 152, transaction 165 into transaction queue 160 with an amount based on the accrued credit amount. Once transaction 165 is successfully processed, the accrued credit amount can be reset to zero.

### DISABLING VEHICLE OPERATION

FIG. 2G is a flow diagram that depicts an example process 290 that mobile device 110 may perform to disable operation of vehicle 120 via digital vehicle key 182 when an associated account is past due.

Referring to FIG. 1, in block 292, mobile device 110 receives a request to authorize transactions for digital account 152 associated with a user identifier. For example, block 292 may correspond to the onboarding process described above.

In block 294, after confirming an approval of the request, mobile device 110 retrieves digital vehicle key 182 comprising a vehicle identifier and a user identifier, wherein digital vehicle key 182 enables access and operation of vehicle 120 associated with the vehicle identifier. An example implementation of block 294 is described in conjunction with FIG. 3A below. The approval of the request may be contingent on various conditions, such as signing a rental agreement and/or providing evidence of a present condition of vehicle 120, e.g. by mobile device 110 capturing photographs or videos of the interior and/or exterior of vehicle 120.

In block 296, mobile device 110 determines when one or more outstanding transactions for digital account 152 exceed a threshold. For example, block 296 may proceed similarly to block 242 as described in FIG. 2C above.

In block 298, mobile device 110 prevents digital vehicle key 182 from enabling operation of vehicle 120 while the one or more outstanding transactions are determined to exceed the threshold. For example, native app 112 and browser 114 may be configured to restrict operation of vehicle 120 until the outstanding transactions no longer exceed the threshold.

In some implementations, mobile device 110 may also prevent operation of vehicle 120 in response to determining that an unsafe condition exists for the vehicle. For example, if an accident is detected to occur, e.g. via gyroscope, accelerometer, GPS, and other sensor data, native app 112 and browser 114 may be configured to restrict operation of vehicle 120 until the unsafe condition no longer exists. Removal of the unsafe condition may include reporting of the accident and provision of insurance information to relevant parties.

### SEQUENCE TO GENERATE A DIGITAL VEHICLE KEY

FIG. 3A is a sequence diagram that depicts an example process 300 to generate a digital vehicle key.

Referring to FIG. 1, in step 310, mobile device 110 sends a request to digital vehicle key server 170 to create digital vehicle key 182. For example, step 310 may correspond to mobile device 110 using key API 175 to request digital vehicle key 182 for vehicle 120, which may be associated with a specific user and having a defined period of validity, as described above.

In step 320, digital vehicle key server 170 generates and stores digital vehicle key 182 with secure lookup token 184 into database 180. As described herein, a SQL INSERT command may be issued to store these records in database 180.

In step 330, digital vehicle key server 170 sends an onboarding link with secure lookup token 184 to mobile device 110. Once the onboarding process is completed at mobile device 110, the actual digital vehicle key 182 can be retrieved via secure lookup token 184, as described in conjunction with FIG. 4A below.

### USER INTERFACE FOR LINKING DIGITAL ACCOUNT TO DIGITAL VEHICLE KEY

FIG. 3B is an example user interface 340 on mobile device 110 for associating a digital account with a digital vehicle key. For example, after mobile device 110 receives the onboarding link and the user accesses the onboarding link, user interface 340 may appear on mobile device 110, for example by triggering native app 112 or browser 114. In some implementations, the user may be prompted to download native app 112 if it does not already exist on mobile device 110. As shown in FIG. 3B, the user of mobile device 110 can press button 350 to begin the onboarding process, wherein digital account 152 is associated with digital vehicle key 182.

### SEQUENCE TO OBTAIN A DIGITAL VEHICLE KEY

FIG. 4A is a sequence diagram that depicts an example process 400 to obtain digital vehicle key 182 and vehicle state 195 using secure lookup token 184.

Referring to FIG. 1, in step 410, mobile device 110 sends a request to digital vehicle key server 170 to retrieve digital vehicle key 182 via secure lookup token 184. For example, after process 300, mobile device 110 may send secure lookup token 184 via key API 175 to request retrieval of digital vehicle key 182.

In step 420, digital vehicle key server 170 retrieves digital vehicle key 182 from database 180. For example, a SQL SELECT command may be issued to database 180 using secure lookup token 184.

In step 430, database 180 returns digital vehicle key 182 to digital vehicle key server 170.

In step 440, digital vehicle key server 170 requests vehicle state 195 from vehicle state store 190 if digital vehicle key 182 is active. For example, if the current date and time is within the period of validity defined in digital vehicle key 182, digital vehicle key 182 may be determined to be active.

In step 450, vehicle state store 190 returns vehicle state 195 to digital vehicle key server 170.

In step 460, digital vehicle key server 170 returns digital vehicle key 182 and vehicle state 195 to mobile device 110. This data can be used by mobile device 110 to provide a user interface for unlocking and operating various aspects of vehicle 120, as shown in conjunction with FIG. 4B below.

### USER INTERFACE FOR VEHICLE OPERATION USING DIGITAL VEHICLE KEY

FIG. 4B is an example user interface 470 on mobile device 110 for operation of vehicle 120 using digital vehicle key 182.

As shown in user interface 470, the user can trigger buttons 480 to operate various aspects of vehicle 120, including opening a front trunk, opening a back trunk, adjusting climate controls, and unlocking vehicle 120. Slide element 482 may be used to unlock and start vehicle 120. Alternatively, element 482 may be a selectable button. Vehicle state 195 can be used to ensure buttons 480 and slide element 482 correctly reflect the current state of vehicle 120 and perform the expected operations when the user interacts with buttons 480.

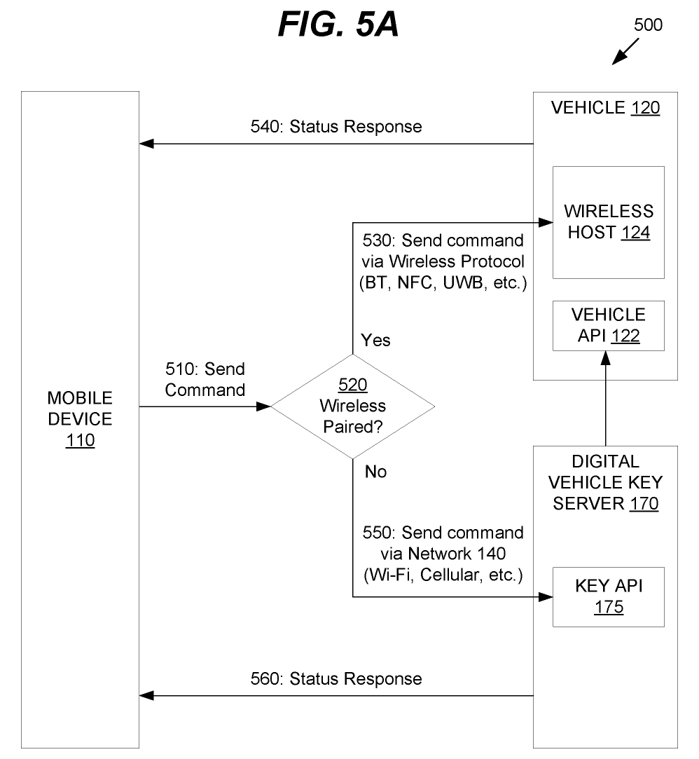

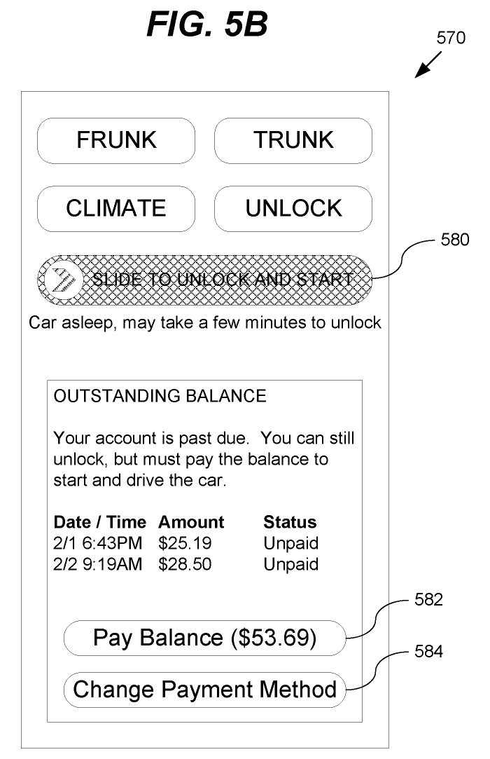

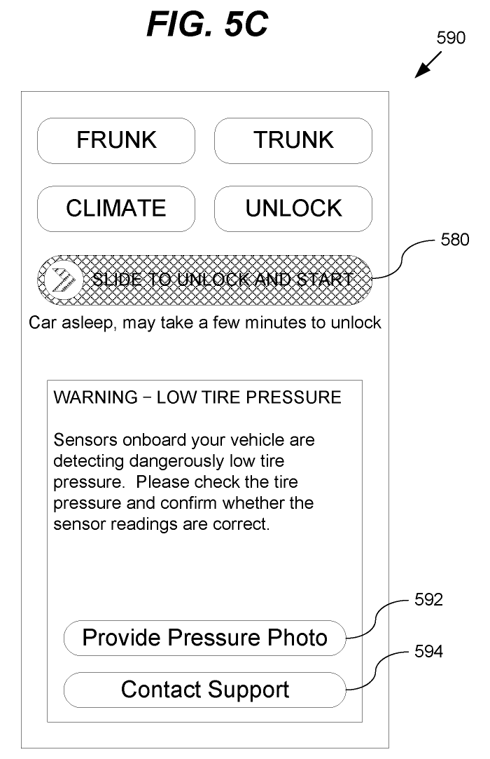

If an outstanding balance is associated with digital account 152, then an informational message may be displayed as shown in user interface 470, and the user may be given the opportunity to bring the account into good standing by attempting another transaction via button 484 and/or changing stored payment information for digital account 152 via button 486. When the outstanding balance exceeds a threshold, some operations in user interface 470 may be disabled, as shown in conjunction with FIG. 5B below.

### SEQUENCE TO SEND COMMANDS TO OPERATE A VEHICLE

FIG. 5A is a sequence diagram that depicts an example process 500 to send commands to operate vehicle 120 using various protocols.

Referring to FIG. 1, in step 510, mobile device 110 sends a command to vehicle 120. For example, the command may correspond to one of the operations shown in user interface 470.

In step 520, mobile device 110 determines whether mobile device 110 is paired with wireless host 124 of vehicle 120. If so, process 500 proceeds to step 530, or sending the command via a wireless protocol. As discussed above, the wireless protocol may be selected according to a hierarchy wherein protocols with less latency are preferred. Vehicle 120 may then perform the command and provide a status response in step 540.

If mobile device 110 is not paired with wireless host 124 or wireless protocols are unavailable at step 520, process 500 proceeds to step 550, wherein the command is sent via network 140 to digital vehicle key server 170 via key API 175. For example, when mobile device 110 is connected to a Wi-Fi network, the command may be sent to network 140 via the Wi-Fi network connection. When no Wi-Fi network is available, the command may be sent to network 140 via a cellular network, satellite network, or an alternative network connection, depending on availability. Digital vehicle key server 170 may then forward the command to vehicle 120 via network 140 using vehicle API 122 and also provide a status response in step 560. In this manner, multiple communication protocols can be attempted for greater reliability.

### USER INTERFACE WITH DISABLED VEHICLE OPERATION

FIG. 5B is an example user interface 570 on mobile device 110 showing disabled operation of a vehicle via digital vehicle key 182 when an associated account is past due.

As shown in user interface 570, an informational message is shown indicating that the outstanding balance exceeds a threshold, or is past due, and lists all of the outstanding charges. Slide element 580 (which may be a button) is now disabled, preventing the user from starting vehicle 120. In the case of EVs and other connected vehicles, may also issue a command via vehicle API 122 to prevent vehicle startup. Otherwise, for non-connected vehicles, may issue an immobilization command to a lock unit or other device preinstalled in vehicle 120, such as a wheel lock, pedal lock, or ignition lock. Buttons 582 and 584 are provided to allow the user to pay the outstanding balance and reactivate slide element 580. Further, as discussed above, unsafe conditions may also disable certain operations of vehicle 120 within user interface 570.

FIG. 5C is an example user interface 590 on mobile device 110 showing disabled operation of a vehicle via digital vehicle key 182 when an unsafe condition is detected. The informational message in user interface 590 informs the user that sensors in vehicle 120 have detected dangerously low tire pressure, and the user is invited to check the tire pressure. Slide element 580 is disabled, preventing the user from starting vehicle 120. If the sensor readings are in error and the tire pressure is safe, the user can select button 592 to resolve the unsafe condition, e.g. by providing photographic proof of adequate tire pressure. If the proof is validated, then slide element 580 can be enabled. Alternatively, the user can select button 594 and speak with an agent to determine how best to remove the unsafe condition and reenable slide element 580. Other unsafe conditions that disable slide element 580 may include accidents, vehicle repair / maintenance issues, and detecting an unknown or unauthorized driver. For example, biometric sensors (e.g. fingerprint sensors, facial recognition depth camera, etc.) may be utilized to determine whether an authorized user is in possession of mobile device 110, and slide element 580 may be disabled if biometric authentication fails.

### SEQUENCE TO GATHER CHARGE EVENTS FOR REIMBURSEMENT

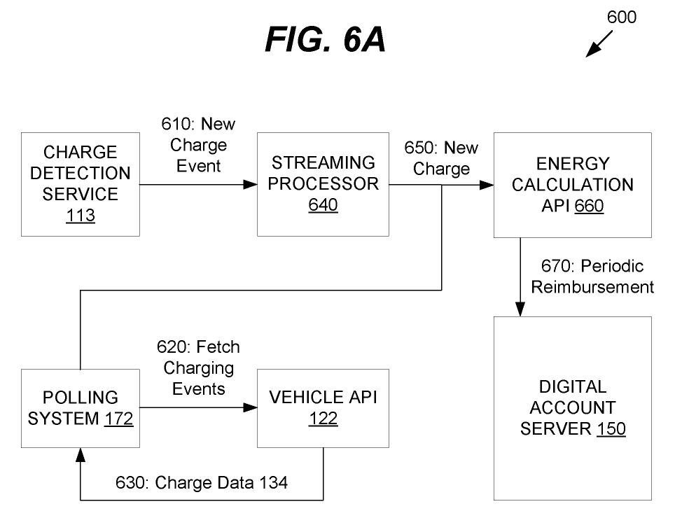

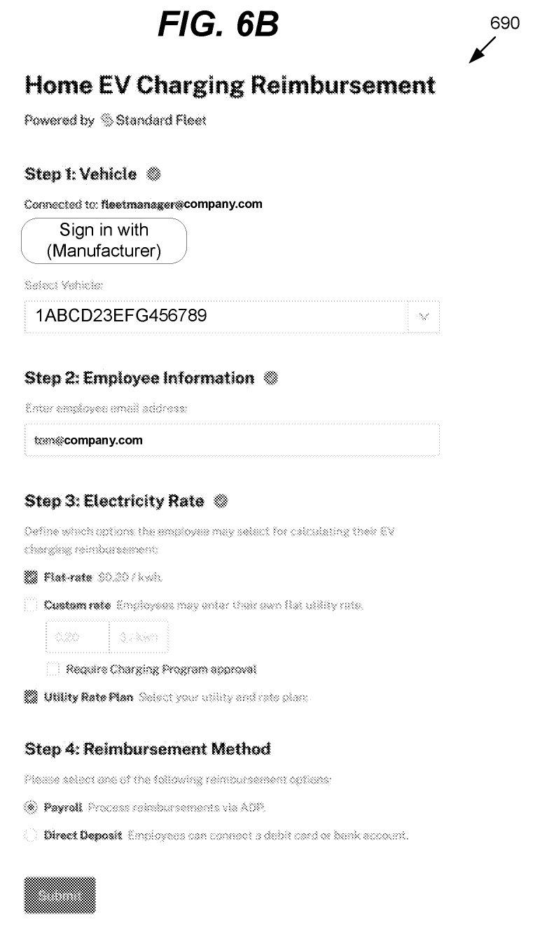

FIG. 6A is a sequence diagram that depicts an example process 600 to gather charge events for periodic reimbursement.

Referring to FIG. 1, in step 610, charge detection service 113 sends a new charge event to streaming processor 640. For example, the new charge event may correspond to a home charging session. Streaming processor 640 may run as a service on digital vehicle key server 170 or another device.

In step 620, polling system 172 fetches charging events using vehicle API 122. In response, charge data 134 is provided to polling system 172. If charge data 134 qualifies as a valid charge for reimbursement, e.g. by occurring at an approved location, then charge data 134 is further forwarded in step 650.

In step 650, charge events originating from streaming processor 640 or polling system 172 are provided as new charges to energy calculation API 660. Energy calculation API 660 may be hosted on digital vehicle key server 170 or another device, and may apply a predetermined electrical rate associated with digital vehicle key 182, as described in conjunction with FIG. 6B below.

In step 670, periodic reimbursements are submitted to digital account server 150. For example, on a daily, weekly, or bi-weekly schedule, the reimbursements determined by energy calculation API 660 can be accrued and submitted to digital account server 150.

### USER INTERFACE TO PROVIDE HOME CHARGING REIMBURSEMENT

FIG. 6B is an example user interface 690 for an employer to provide digital vehicle key 182 with charge reimbursement to an employee.

As shown in user interface 690, in step 1 the employer may select vehicle 120 as a company sponsored vehicle. In step 2 the employer may select a user or employee. In step 3 the employer may define an electricity rate, which may be a predetermined flat rate, a custom rate defined by the employee, or a utility rate, which may include TOU rates. In step 4, digital account 152 may be defined as a payroll account for the employee, or a direct deposit into a bank account of the employee. In this manner, company sponsored vehicles with reimbursement for charging costs can be readily provided to employees.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

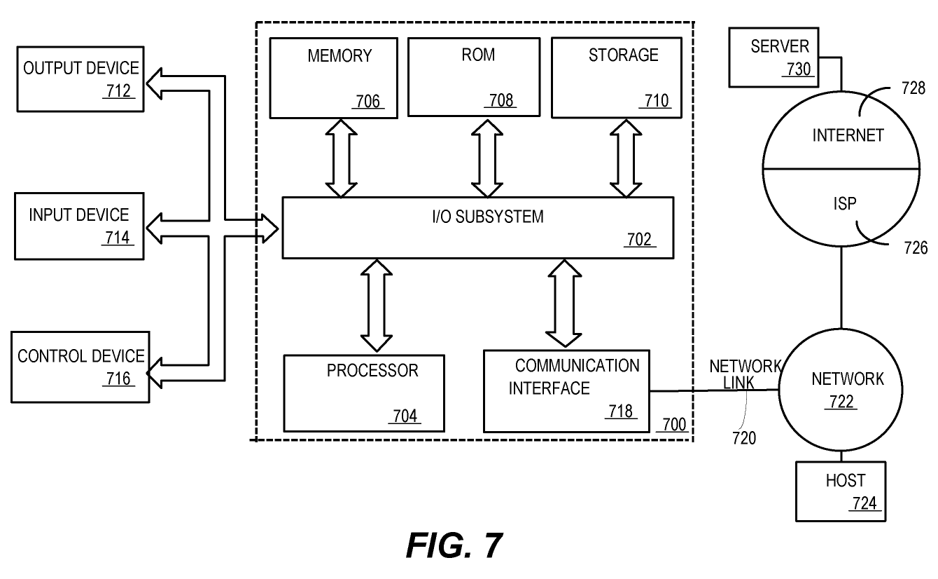

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 1030 might transmit a requested code for an application program through Internet 728, ISP 726, local network 722 and communication interface 718.

The received code may be executed by processor 704 as it is received, and/or stored in storage device 710, or other non-volatile storage for later execution.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### SOFTWARE OVERVIEW

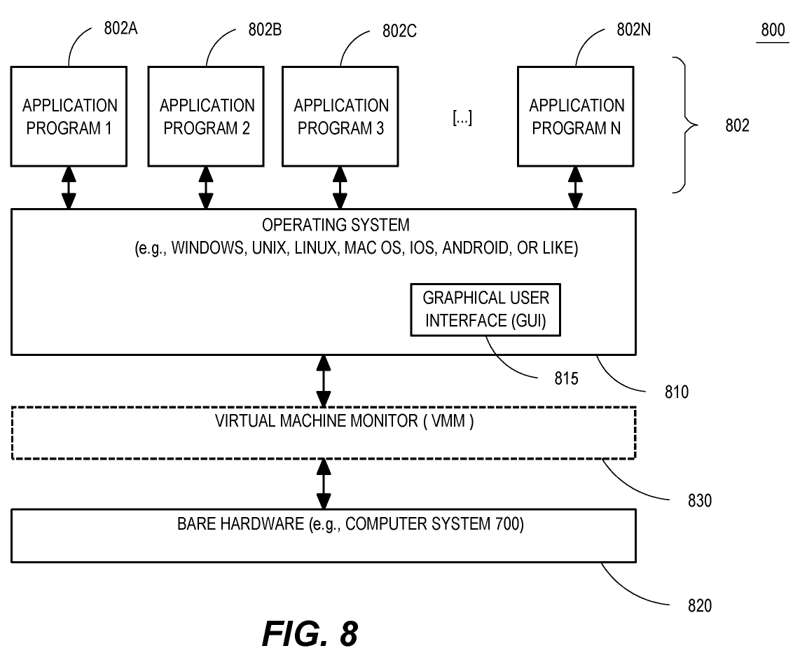

FIG. 8 is a block diagram of a basic software system 800 that may be employed for controlling the operation of computing device 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing device 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C … 802N, may be “loaded” (e.g., transferred from fixed storage 710 into memory 706) for execution by the system 800. The applications or other software intended for use on device 800 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of device 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the device 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of device 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### EXTENSIONS AND ALTERNATIVES

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a request to authorize transactions for a digital account associated with a user identifier;
after confirming an approval of the request, retrieving a digital vehicle key comprising a vehicle identifier and the user identifier, wherein the digital vehicle key enables access and operation of a vehicle associated with the vehicle identifier;
determining when one or more outstanding transactions for the digital account exceed a threshold; and
preventing the digital vehicle key from enabling operation of the vehicle while the one or more outstanding transactions are determined to exceed the threshold.

2. The method of claim 1, wherein confirming the approval of the request is in response to receiving photographic evidence of a present condition of the vehicle.

3. The method of claim 1, wherein the threshold comprises at least one of: an aggregate amount due for the digital account, and a predetermined number of failed attempted transactions for the digital account.

4. The method of claim 1, further comprising:
determining that an unsafe condition exists for the vehicle; and
preventing the digital vehicle key from enabling operation of the vehicle while the unsafe condition is determined to exist.

5. The method of claim 4, wherein the unsafe condition includes detecting an accident.

6. The method of claim 1, wherein the retrieving of the digital vehicle key comprises:
sending a second request to create the digital vehicle key to a digital vehicle key server; and
receiving an onboarding link with a secure lookup token associated with the digital vehicle key.

7. The method of claim 6, wherein the retrieving of the digital vehicle key comprises:
requesting, from the digital vehicle key server, the digital vehicle key via the secure lookup token; and
receiving, from the digital vehicle key server, the digital vehicle key with a vehicle state, wherein the vehicle state is for the vehicle associated with the vehicle identifier.

8. The method of claim 7, wherein the vehicle state defines, for the vehicle associated with the vehicle identifier, at least one of: lock state of one or more doors, lock state of one or more hoods, open state of one or more windows, engine running state, or climate control state.

9. The method of claim 7, further comprising:
presenting a user interface to adjust the vehicle state.

10. The method of claim 9, further comprising:
determining a command to adjust the vehicle state in response to one or more inputs received from the user interface;
determining a pairing status with the vehicle associated with the vehicle identifier; and
sending the command, based on the pairing status, to either the digital vehicle key server or directly to the vehicle associated with the vehicle identifier.

11. One or more non-transitory computer-readable media storing instructions that, when executed by one or more processors, cause:
receiving a request to authorize transactions for a digital account associated with a user identifier;
after confirming an approval of the request, retrieving a digital vehicle key comprising a vehicle identifier and the user identifier, wherein the digital vehicle key enables access and operation of a vehicle associated with the vehicle identifier;
determining when one or more outstanding transactions for the digital account exceed a threshold; and
preventing the digital vehicle key from enabling operation of the vehicle while the one or more outstanding transactions are determined to exceed the threshold.

12. The one or more non-transitory computer-readable media of claim 11, wherein confirming the approval of the request is in response to receiving photographic evidence of a present condition of the vehicle.

13. The one or more non-transitory computer-readable media of claim 11, wherein the threshold comprises at least one of: an aggregate amount due for the digital account, and a predetermined number of failed attempted transactions for the digital account.

14. The one or more non-transitory computer-readable media of claim 11, wherein the instructions further cause:
determining that an unsafe condition exists for the vehicle; and
preventing the digital vehicle key from enabling operation of the vehicle while the unsafe condition is determined to exist.

15. The one or more non-transitory computer-readable media of claim 14, wherein the unsafe condition includes detecting an accident.

16. The one or more non-transitory computer-readable media of claim 11, wherein the retrieving of the digital vehicle key comprises:
sending a second request to create the digital vehicle key to a digital vehicle key server; and
receiving an onboarding link with a secure lookup token associated with the digital vehicle key.

17. The one or more non-transitory computer-readable media of claim 16, wherein the retrieving of the digital vehicle key comprises:
requesting, from the digital vehicle key server, the digital vehicle key via the secure lookup token; and
receiving, from the digital vehicle key server, the digital vehicle key with a vehicle state, wherein the vehicle state is for the vehicle associated with the vehicle identifier.

18. The one or more non-transitory computer-readable media of claim 17, wherein the vehicle state defines, for the vehicle associated with the vehicle identifier, at least one of: lock state of one or more doors, lock state of one or more hoods, open state of one or more windows, engine running state, or climate control state.

19. The one or more non-transitory computer-readable media of claim 17, wherein the instructions further cause:
presenting a user interface to adjust the vehicle state.

20. The one or more non-transitory computer-readable media of claim 19, wherein the instructions further cause:
determining a command to adjust the vehicle state in response to one or more inputs received from the user interface;
determining a pairing status with the vehicle associated with the vehicle identifier; and
sending the command, based on the pairing status, to either the digital vehicle key server or directly to the vehicle associated with the vehicle identifier.
